(19) United States
(12) Patent Application Publication
(10) Pub. No.: US 2010/0308943 A1
(43) Pub. Date: Dec. 9, 2010

(54) RESIDUAL-CURRENT CIRCUIT BREAKER

(75) Inventor: Gerhard Dobusch, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Eaton GmbH

(21) Appl. No.: 12/867,114

(22) PCT Filed: Feb. 2, 2009
(86) PCT No.: PCT/AT09/00040

§ 371 Date: Aug. 11, 2010

(30) Foreign Application Priority Data
Feb. 14, 2008 (AT) A 242/2008

(51) Int. Cl. H01H 77/06

(52) U.S. Cl. 335/7

(57) ABSTRACT

A residual-current circuit breaker has a mains voltage-independent fault current breaking and includes at least one summation current converter, through which at least one first conductor and a second conductor of a network to be protected are run. Disposed on the summation current converter is at least one secondary winding. The secondary winding in terms of the circuit design is connected to a breaker, which is operatively connected via a switch latch to break contacts in the at least one first conductor and the at least one second conductor. Further disposed on the summation current converter is a tertiary winding, which in terms of the circuit design is connected to at least one voltage-dependent resistor. In order to use a test resistor having a small size, while foregoing a switch contact in the test current circuit, the tertiary winding is configured as part of the test current circuit which includes a test sensor and a test resistor.

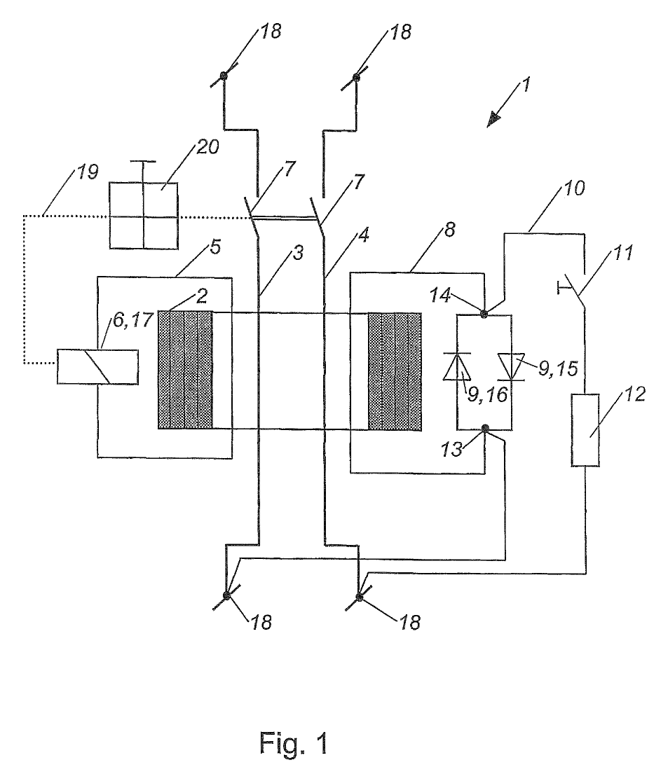

The invention relates to a residual-current circuit breaker according to the preamble of claim 1.

In accordance with relevant international, national and regional regulations, residual-current circuit breakers must comprise a testing device for testing the proper function of fault current tripping. Such a testing device usually comprises a test resistor and a test button, with a test current circuit being closed upon actuating the test button and, in this way, a simulated fault current being generated from one conductor to another conductor past a summation current transformer. If the residual-current circuit breaker works correctly, it is tripped and the break contacts of the residual-current circuit breaker will disconnect the conductor of a network to be protected. In the case of such testing devices which are arranged in an especially simple way, the test resistor should be able to thermally cope with powers of approx. 30 W which occur during a simulated residual current. Such a resistor would be relatively large and expensive, which is why a so-called auxiliary contact is arranged in the test current circuit which also disconnects the test current circuit when the break contacts are opened. As a result, the thermal load on the test resistor can be kept at a low level because the test resistor only needs to cope with the power merely for the period between the actuation of the test button and the tripping of the residual-current circuit breaker. The provision of such an auxiliary contact in the test current circuit and its connection to the break contacts is complex from a constructional and production viewpoint and requires a further expensive component in the form of the auxiliary switch.

It is therefore the object of the invention to provide a residual-current circuit breaker of the kind mentioned above with which the mentioned disadvantages can be avoided and which with a test resistor of small overall size can be used under omission of a switching contact in the test current circuit and which has a simple configuration from a constructional viewpoint.

This is achieved in accordance with the invention by the features of claim 1.

A test resistor of small overall size can thus be used in a residual-current circuit breaker under omission of a switching contact in the test current circuit. As a result of the considerably increased coil number or number of windings with which the test current circuit is coupled with the summation current transformer, which number is increased over the state of the art, the test resistor can be provided with a substantially higher ohmic resistance than before. As a result, the current through the test resistor and thus the power draw of the test resistor can be reduced. A test resistor can thus be used which needs to have a lower thermal resilience and is nevertheless suitable for permanent operation, so that the auxiliary contacts which are complex in respect of construction and production and used for disconnecting the test current circuit can be omitted. Resistors with a lower thermal resilience have considerably reduced dimensions in comparison with resistors with a higher thermal resilience. The constructional and production effort for forming a residual-current circuit breaker can thus be reduced considerably. The costs for forming a residual-current circuit breaker can be lowered by omitting an auxiliary contact and by the lower necessary thermal resilience of the test resistor. By using the tertiary winding as a part of the test current circuit it is possible to use components in multiple ways that are already provided in a residual-current circuit breaker, so that further resources can be saved.

The sub-claims, which like claim 1 simultaneously form a part of the description, relate to further advantageous developments of the invention.

The invention will be explained in closer detail by reference to the only enclosed drawings which merely shows a preferred embodiment of a residual-current circuit breaker as a schematic circuit diagram.

The only drawing shows a residual-current circuit breaker 1 with mains-voltage-independent residual current tripping, comprising at least one summation current transformer 2, through which at least one first conductor 3 and one second conductor 4 of a network to be protected are guided, with at least one secondary winding 5 being disposed on the summation current transformer 2, the secondary winding 5 in terms of the circuit design being connected to a trip element 6 which is operatively connected via a breaker mechanism 20 with break contacts 7 in the at least one first conductor 3 and the at least one second conductor 4, with furthermore a tertiary winding 8 being disposed on the summation current transformer 2, which in terms of the circuit design is connected to at least one voltage-dependent resistor 9, with the tertiary winding 8 being part of a test current circuit 10 comprising a test button 11 and a test resistor 12.

As a result, a test resistor 12 of small size can be inserted in a residual-current circuit breaker 1 under omission of a switching contact in the test current circuit 10. As a result of the considerably increased coil number or number of windings in comparison with the state of the art with which the test current circuit 10 is coupled with the summation current transformer 2, the test resistor 12 can be arranged with a considerably higher ohmic resistance than before. As a result, the current through the test resistor 12 and thus the power draw of the test resistor 12 can be reduced. A test resistor 12 can thus be used which needs to have a lower thermal resilience and is nevertheless suitable for permanent operation, so that an auxiliary contact which is complex in respect of construction and production and used for disconnecting the test current circuit 10 can be omitted. Resistors with a lower thermal resilience have considerably reduced dimensions in comparison with resistors with a higher thermal resilience. The constructional and production effort for forming a residual-current circuit breaker 1 can thus be reduced considerably. The costs for forming a residual-current circuit breaker 1 can be lowered by omitting an auxiliary contact and by the lower necessary thermal resilience of the test resistor 12. By using the tertiary winding 8 as a part of the test current circuit 10 it is possible to use components in multiple ways that are already provided in a residual-current circuit breaker, so that further resources can be saved.

A resistor is designated as a test resistor 12 within the terms of the present invention which acts as a purely ohmic resistor, or acts as a purely ohmic resistor at the frequency of the network to be protected.

The only drawing shows a merely especially preferred embodiment of a residual-current circuit breaker 1 in accordance with the invention for residual current tripping independent of mains voltage as a schematic illustration of the functional components. Such a residual-current circuit breaker 1 is provided for the protection of installations and humans. In the case of an occurring hazardous residual current, the consumers which are connected to the residual-current circuit breaker 1 are disconnected from a supply network comprising a first conductor 3 and a second conductor 4. The residual-current circuit breaker comprises terminals 18, especially screw-type terminals, for the connection of at least one first and one second conductor 3, 4 of an electric supply network. The illustrated schematic circuit diagram shows an embodiment with merely one first and one second conductor 3, 4. Embodiments with any predeterminable number of leads or conductors of an electric power-supply network can be provided, especially embodiments with three or four conductors, for the protection of a three-phase load connected to a three-phase network. The further description relates to the illustrated embodiment with a first and a second conductor 3, 4, with this including embodiments with several conductors in an accordingly equivalent manner. So-called break contacts 7 are arranged in the first and second conductor 3, 4, which are therefore switching contacts and are provided and arranged for disconnecting or interrupting the first or second conductor and for subsequent closing. The described components or modules illustrated in the drawing are arranged jointly in an insulant housing which comprises breakthroughs at least for the terminals 18 and a manually actuated switch lever for manually opening or closing the break contacts 7. It can further be provided that a residual-current circuit breaker 1 in accordance with the invention comprises further modules or components which are not shown or described such as switch-position indicator, a trip indicator and the like.

A residual-current circuit breaker 1 in accordance with the invention comprises in the known manner at least one summation current transformer 2 with a transformer core comprising a magnetic material, through which a first and second conductor 3, 4 are guided as a primary winding. It can be provided to guide the first and second conductor 3, 4 merely through a substantially central opening of the summation current transformer 2, or to wind the same about the transformer core. A secondary winding 5 for detecting a fault current signal is further arranged on the summation current transformer 2, with the secondary winding 5 being connected in terms of the circuit design with the trip element 6, which is preferably arranged as a permanent magnet trip element 17, thus achieving an especially secure and rapid response of residual-current circuit breaker 1. The trip element 6 acts mechanically via a breaker mechanism 20 on the break contacts 7, which is indicated in the drawing by a dotted line 19. Upon occurrence of a dangerous fault current, a respective fault current signal is generated in the secondary winding 5, with the trip element 6 acting upon the break contacts 7 which are opened, thus separating the first and second conductor 3, 4.

The components arranged in such a residual-current circuit breaker 1 which is independent of line voltage for detecting a fault current and for tripping the residual-current circuit breaker 1, which therefore is a disconnection of the break contacts 7, obtain their power required for tripping completely from the fault current or from the fault current signal in the secondary winding 5 which is proportional thereto, and do not comprise any active electronic components such as transistors and/or operational amplifiers and any separate power units for supplying active components.

Residual-current circuit breakers 1 are provided to protect humans and installations from the effects of electric residual currents and disconnect installations and consumers from an electric supply network in respectively hazardous situations. Undesirable tripping as a result of residual currents which are benign as a result of their occurrence over an extremely short period shall be prevented to the highest possible extent. A residual-current circuit breaker 1 comprises a so-called tertiary winding 8 or protective winding on the summation current transformer 2 in addition to the secondary winding 5 for the detection of residual currents for tripping the residual-current circuit breaker 1. The ends of this tertiary winding 8 are connected to at least one voltage-dependent resistor 9. The tertiary winding and the voltage-dependent resistor 9 are dimensioned in such a way that the voltage-dependent resistor 9 will switch through at a predeterminable voltage, the tertiary winding 8 will thus be conductive with a low resistance, and energy is withdrawn from the residual current signal induced in the secondary winding 5. As a result, false trippings as a result of short-term network disturbances can thus be prevented.

Any voltage-dependent resistor 9 such as a varistor can be provided as a voltage-dependent resistor 9. It is provided in an especially preferred manner as shown in the drawing that the voltage-dependent resistor 9 is arranged as at least one diode 15, 16, so that an especially simple and cost-effective configuration of a residual-current circuit breaker 1 is achieved. In order to ensure the illustrated protection from false tripping also in the preferred use of a residual-current circuit breaker 1 at alternating currents as are conventionally used in the supply networks, it is especially preferably provided as shown in the drawing that a first diode 15 and a second diode 16 are connected to the tertiary winding 8, with the first diode 15 being switched parallel to the second diode 16, and the first diode 15 being arranged in an antipolar manner in relation to the second diode 16. In an antipolar manner shall mean in this case that the directions of flow of the two diodes 15, 16 switched in parallel are each arranged oppositely.

It is provided in accordance with the invention that the tertiary winding 8 is part of a test current circuit 10 comprising a test button 11 and test resistor 12. Any kind of connection of the tertiary winding 8 to the test current circuit 10 or any kind of integration of the tertiary winding 8 in the test current circuit can be provided with which the illustrated advantages and effects can be achieved.

It is provided in an especially preferred and illustrated embodiment of the present invention that a first end 13 of the tertiary winding 8 is connected with the first conductor 3 in terms of circuit design, a second end 14 of the tertiary winding 8 with the test button 11 in terms of circuit design, the test button 11 is connected with the test resistor 12 in terms of circuit design, and the test resistor 12 is connected with the second conductor 4 in terms of circuit design. The term connected in terms of circuit design shall designate an electrically conductive connection, preferably a welded, soldered, crimped and/or clamped connection. It can be provided, as shown in the drawing, that the connections of the test current circuit 10 with the first and second conductor 3, 4 are arranged on the same side of the summation current transformer 2. It can also be provided that the connections of the test current circuit 10 with the first and second electric conductor 3, 4 are arranged on different sides of the summation current transformer 2.

What is claimed is:

1.-5. (canceled)

6. A residual-current circuit breaker with mains-voltage-independent residual current tripping, comprising:
at least one summation current transformer, through which at least one first conductor and one second conductor of a network to be protected are guided;
at least one secondary winding disposed on the summation current transformer;
a trip element connected to the secondary winding and operatively connected via a breaker mechanism with break contacts in the at least one first conductor and the at least one second conductor;
at least one voltage-dependent resistor; and
a tertiary winding disposed on the summation current transformer for avoiding false tripping, said tertiary winding connected to the at least one voltage-dependent resistor, wherein the tertiary winding and the voltage-dependent resistor are dimensioned in such a way that the voltage-dependent resistor switches through at a predeterminable voltage to withdraw energy from a residual current signal induced in the secondary winding, said tertiary winding being part of a test current circuit.

7. The residual-current circuit breaker of claim 6, wherein the test current circuit includes a test resistor connected with the second conductor, and a test button connected with the test resistor, said tertiary winding having a first end connected with the first conductor, and a second end connected with the test.

8. The residual-current circuit breaker of claim 6, wherein the voltage-dependent resistor is configured as at least one diode.

9. The residual-current circuit breaker of claim 6, further comprising a first and second diodes connected to the tertiary winding, with the first diode being switched parallel to the second diode and arranged in an antipolar manner in relation to the second diode.

10. The residual-current circuit breaker of claim 6, wherein the trip element is configured as a permanent magnet trip element.
